(19) United States
(12) Patent Application Publication
(10) Pub. No.: US 2010/0082535 A1
(43) Pub. Date: Apr. 1, 2010

(54) Method and System for Uploading Advertisement Content

(75) Inventors: Neel Kamal, Sunnyvale, CA (US); Maarten van Egmond, Santa Clara, CA (US); Vivek Hariharan, Sunnyvale, CA (US); Graham S.T. Harris, Westlake Village, CA (US); Treven Ho, Los Angeles, CA (US)

Correspondence Address: MPG, LLP AND YAHOO! INC., 710 LAKEWAY DRIVE, SUITE 200, SUNNYVALE, CA, 94085, US

(73) Assignee: Yahoo! Inc., Sunnyvale, CA (US)

(21) Appl. No.: 12/242,626

(22) Filed: Sep. 30, 2008

(51) Int. Cl. G06F 17/30

(52) U.S. Cl. 707/610; 707/E17.005; 707/829

(57) ABSTRACT

A method and system is disclosed for receiving advertisement content files within a digital advertisement platform operating on a server computing system. Data defining a compressed file is received at the server. The compressed file includes a hierarchical structure of folders and a number of advertisement content files disposed within the hierarchical structure of folders. The hierarchical structure of folders is automatically extracted from the compressed file. The extracted hierarchical structure of folders is automatically created within a content library maintained within the digital advertisement platform. The advertisement content files are automatically extracted from the compressed file. The extracted advertisement content files are stored within the hierarchical structure of folders created within the content library so as to mirror disposition of the advertisement content files in the hierarchical structure of folders within the compressed file.

### BACKGROUND OF THE INVENTION

Online advertising of products and services by business entities continues to increase as more people become connected and reliant upon online content. Online advertising generally includes displaying an advertisement for a product or service in a user's browser when the user is navigating the internet. The particular advertisements that are displayed at a given time may be dependent upon an online context into which the user has navigated, or in some instances upon a historical record of the user's online navigation behavior. When a user clicks on a displayed advertisement, the user may be directed to a website specific to the advertisement, or may be directed to a website that enables purchase of the product or service that is advertised.

Business entities may generate a portfolio of numerous advertisements available to be displayed. The various advertisements may be specified so as to associate more with certain online contexts than others, thereby enabling advertisements to be targeted based on user's online navigation behavior. Also, various advertisements may be specified by a given business entity for the purpose of providing variety in how a given product or service is advertised online. Therefore, business entities may manage a large number of online advertisements of varying content. The content of a given advertisement may include data spread across a number of files. It is of interest to business entities to manage their online advertisements and data associated therewith in an efficient and organized manner.

### SUMMARY OF THE INVENTION

In one embodiment, a method is disclosed for receiving advertisement content files within a digital advertisement platform operating on a server computing system. The method includes receiving data at the server that defines a compressed file. The compressed file includes a hierarchical structure of folders and a number of advertisement content files disposed within the hierarchical structure of folders. The method also includes automatically extracting the hierarchical structure of folders from the compressed file. The method also includes automatically creating the hierarchical structure of folders within a content library maintained within the digital advertisement platform. The method further includes automatically extracting the advertisement content files from the compressed file. The method also includes storing the extracted advertisement content files within the hierarchical structure of folders created within the content library so as to mirror disposition of the advertisement content files in the hierarchical structure of folders within the compressed file.

In another embodiment, a system is disclosed for uploading advertisement content files within a digital advertisement platform operating on a server computing system. The system includes a content library resident on the server. The content library is defined to store advertisement content files within a hierarchical structure of folders. The system also includes a graphical user interface defined to enable uploading of advertisement content files to the content library. The graphical user interface includes a file selection control defined to enable selection of a compressed file for uploading. The compressed file includes a hierarchical structure of folders and a number of advertisement content files disposed within the hierarchical structure of folders. The graphical user interface also includes an upload control defined to initiate, upon activation, an uploading process on the selected compressed file. The uploading process includes automatically creating the hierarchical structure of folders present within the compressed file within the content library. The uploading process also includes automatically extracting the advertisement content files from the compressed file. The uploading process further includes automatically storing the extracted advertisement content files within the hierarchical structure of folders created within the content library, so as to mirror disposition of the advertisement content files in the hierarchical structure of folders within the compressed file.

In another embodiment, a computer readable storage medium having program instructions stored thereon for receiving advertisement content files within a digital advertisement platform operating on a server computing system is disclosed. The computer readable medium includes program instructions for receiving data at the server that defines a compressed file. The compressed file includes a hierarchical structure of folders and a number of advertisement content files disposed within the hierarchical structure of folders. The computer readable medium also includes program instructions for automatically extracting the hierarchical structure of folders from the compressed file. The computer readable medium also includes program instructions for automatically creating the hierarchical structure of folders within a content library maintained within the digital advertisement platform. The computer readable medium also includes program instructions for automatically extracting the advertisement content files from the compressed file. The computer readable medium further includes program instructions for storing the extracted advertisement content files within the hierarchical structure of folders created within the content library, so as to mirror disposition of the advertisement content files in the hierarchical structure of folders within the compressed file.

Other aspects and advantages of the invention will become more apparent from the following detailed description, taken in conjunction with the accompanying drawings, illustrating by way of example the present invention.

### BRIEF DESCRIPTION OF THE DRAWINGS

FIG. 1 is an illustration showing a system for managing online advertisement, in accordance with one embodiment of the present invention;

FIG. 2 is an illustration showing an exemplary APT home page, in accordance with one embodiment of the present invention;

FIG. 3 is an illustration showing an exemplary creatives GUI, in accordance with one embodiment of the present invention;

FIG. 4 is an illustration showing an exemplary upload GUI, in accordance with one embodiment of the present invention; and

FIG. 5 shows a flowchart of a method for receiving advertisement content files within a digital advertisement platform operating on a server computing system, in accordance with one embodiment of the present invention.

### DETAILED DESCRIPTION

In the following description, numerous specific details are set forth in order to provide a thorough understanding of the present invention. It will be apparent, however, to one skilled in the art that the present invention may be practiced without some or all of these specific details. In other instances, well known process operations have not been described in detail in order not to unnecessarily obscure the present invention.

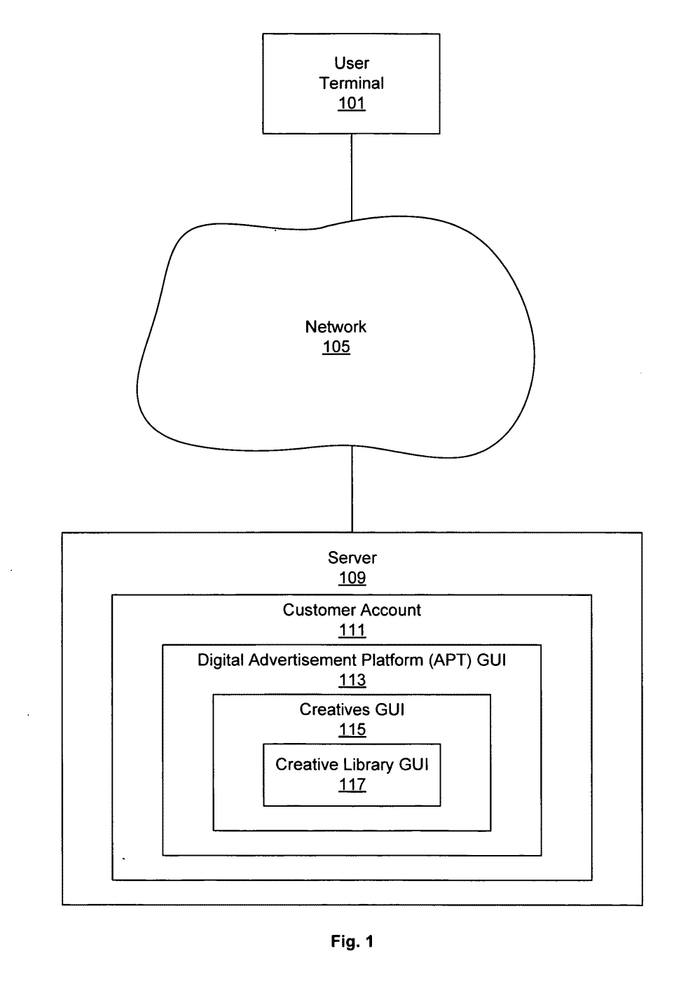

FIG. 1 is an illustration showing a system for managing online advertisement, in accordance with one embodiment of the present invention. In the description herein, the term customer corresponds to an entity that uploads advertisement content, constructs advertisements from the uploaded advertisement content, and manages display of the constructed advertisements. The customer operates a user terminal 101 that is connected to a server 109, through a network 105. The network 105 can be defined in essentially any manner (e.g., wired, wireless, or combination thereof) that provides for bi-directional communication of data between the user terminal 101 and the server 109. The user terminal 101 includes a display device defined to visually render graphical content such as a graphical user interface (GUI).

The server 109 is defined to provide each customer with a private customer account 111. The customer account 111 may be secured by identification and password such that only holders of the identification and password credentials are able to access the customer account 111. The server 109 also executes a transformative digital advertisement platform (“APT” hereafter) 113 that is accessible from within the customer account 111. The APT 113 is rendered as a GUI on the user terminal 101. The APT 113 provides a number of tools and interfaces to enable the customer to create, manage, and analyze their advertisements.

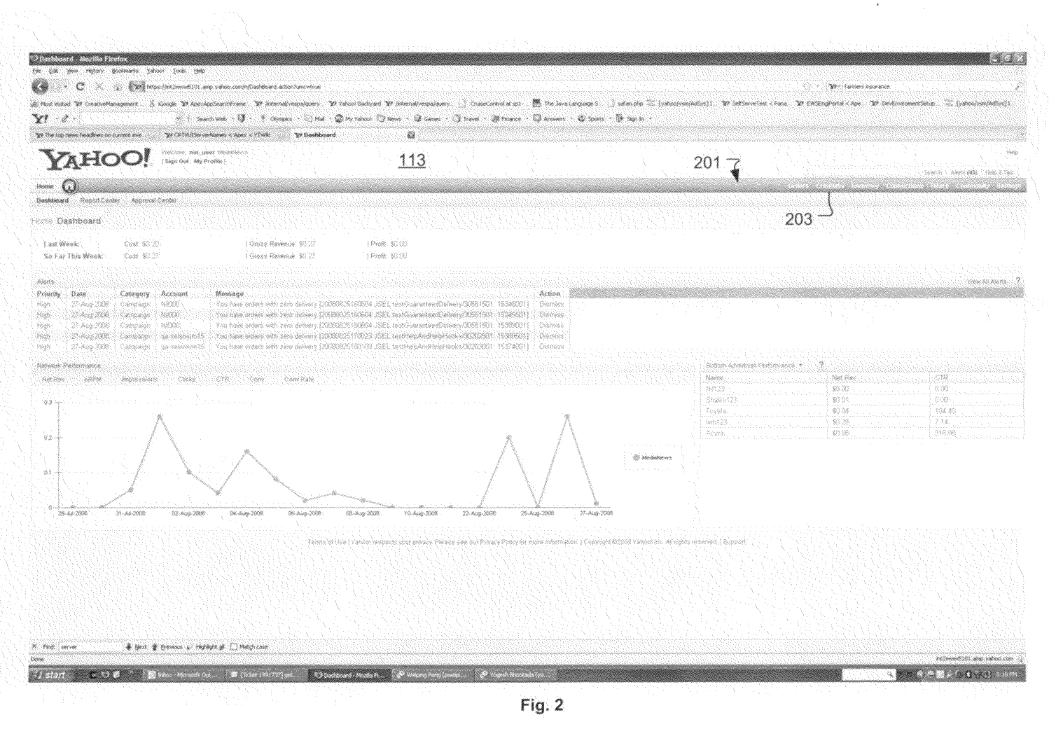

FIG. 2 is an illustration showing an exemplary APT 113 home page, in accordance with one embodiment of the present invention. The APT 113 home page provides a dashboard view that includes a menu bar 201. A control 203 on the menu bar 201 directs the APT 113 to display a creatives GUI 115 on the user terminal 101.

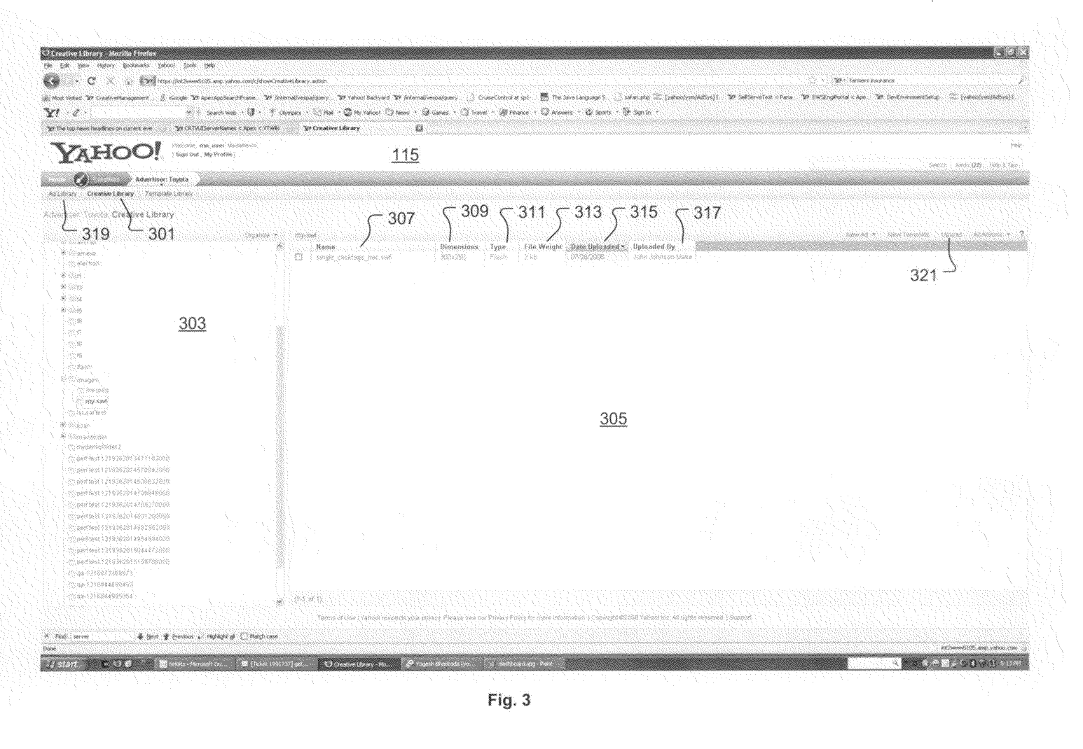

FIG. 3 is an illustration showing an exemplary creatives GUI 115, in accordance with one embodiment of the present invention. The creatives GUI 115 includes a control 301 for displaying a creative library GUI 117. The creative library GUI 117 includes a first display region 303 in which an interactive folder hierarchy is displayed. The folder hierarchy shown in display region 303 is organized in a tree structure. Folders displayed in the region 303 can be expanded to show sub-folders therein, and can be collapsed to hide sub-folders therein. A second display region 305 shows the contents of a currently selected folder in display region 303. Specifically, display region 305 shows each file that is present in the folder that is currently selected in display region 303. Various details of each file may be shown in display region 305. In one embodiment, the file details shown in region 305 include filename 307, graphical image size 309, file type 311, file size 313, upload date 315, and upload source 317. It should be understood that in other embodiments different file information may be displayed in region 305, so long as individual files are identifiable.

The creatives GUI 115 further includes an advertisement library, accessible through control 319. The customer uploads advertisement content files to the content library, which is displayed in the creative library GUI 117. The customer is then able to create advertisements using the content files stored within the content library. The created advertisements are stored in the customer's advertisement library.

It should be appreciated that multiple advertisement content files of varying types may be required by a given customer. Also, it should be appreciated that the folder hierarchy (as shown in display region 303) may become quite complex depending on the number and sophistication of the customer's advertisements. Therefore, a customer may need to upload many advertisement content files and organize them among many different folders in the content library.

In one embodiment, advertisement content files are compressed prior to uploading to reduce the amount of data that must be transmitted through the network 105 between the user terminal 101 and the server 109. In one embodiment, the advertisement content files are compressed into a lossless compression file format that includes a central directory which defines a hierarchical structure of folders within the compressed file. In one embodiment, the hierarchical structure of folders in the compressed file corresponds to a hierarchical structure of folders on the user terminal 101. Therefore, in this embodiment, the customer can control the organization of folders and advertisement content files therein as it exists within the compressed file by organizing the folders and advertisement content files therein in the desired manner on the user terminal 101. In one embodiment, the compressed file is defined in a zip file format. However, it should be understood that in other embodiments different compressed file formats may be used, so long as the compressed file format provides for lossless data compression and includes a central directory which defines a hierarchical structure of folders within the compressed file.

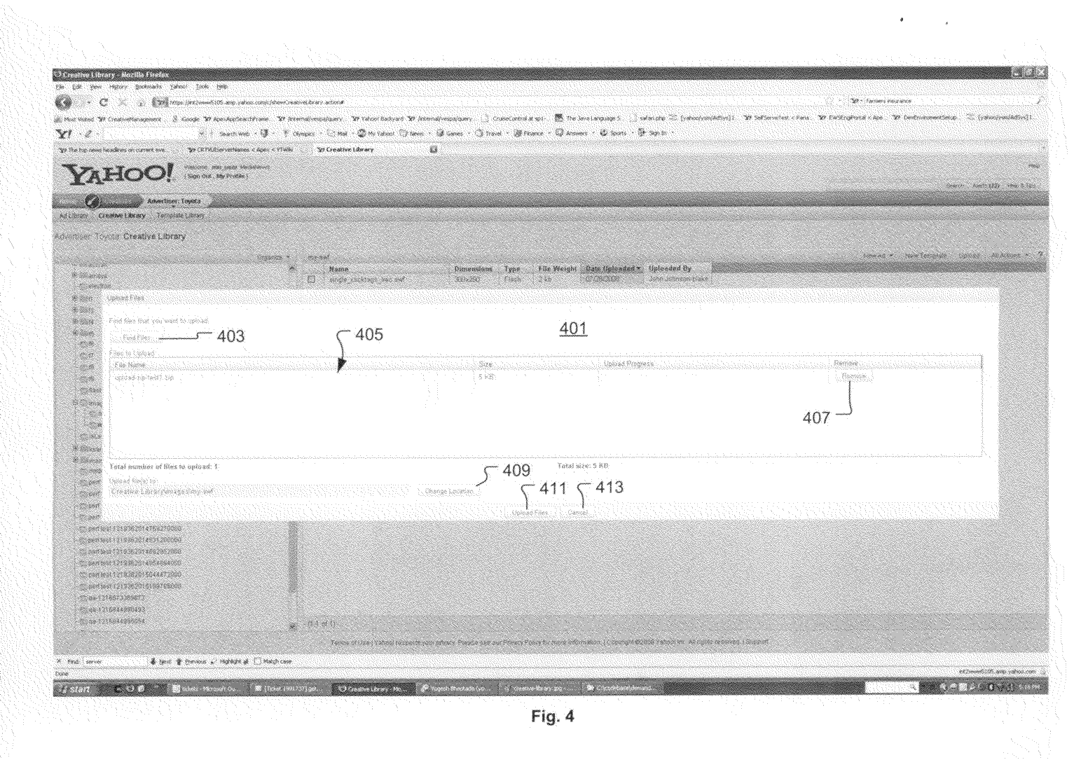

The creative library GUI 117 provides a control 321 for uploading advertisement content files. Upon selection of the control 321, the APT 113 directs display of an upload GUI 401 on the user terminal 101. FIG. 4 is an illustration showing an exemplary upload GUI 401, in accordance with one embodiment of the present invention. The upload GUI 401 is defined to enable uploading of advertisement content files to the content library as rendered in the creative library GUI 117. The upload GUI 401 includes a file selection control 403 defined to enable selection of a compressed file for uploading to the content library on the server 109. It should be understood that the compressed file is selected from a file system accessible through the user terminal 101. This file system may be local to the user terminal 101, or may reside on a network accessible by the user terminal 101, such as network 105 for example.

Selection of the file selection control 403 causes a file system navigation window to be displayed through which the customer is able to navigate to a desired compressed file to be uploaded. Upon selection of the compressed file to be uploaded in the navigation window, the selected compressed file is displayed in a “files to upload” region 405 of the upload GUI 401. In one embodiment, the files to upload region 405 displays a filename and size of the compressed file to be uploaded, an upload status indicator for the compressed file to be uploaded, and provides a remove control 407 for each compressed file to enable removal of the compressed file from the set of files to be uploaded. In one embodiment, the file selection control 403 is defined to enable selection of multiple compressed files for uploading. It should be understood that in other embodiments the files to upload region 405 may present information regarding the files to be uploaded other than what is specifically identified above.

The compressed file includes a hierarchical structure of folders and a number of advertisement content files disposed within the hierarchical structure of folders. The advertisement content files are defined as one or more of text content files, graphical content files, flash content files, and video content files, among others. Examples of advertisement content file formats include JPEG (Joint, Photographic Experts Group), TIFF (Tagged Image File Format), PNG (Portable Network Graphics), GIF (Graphics Interchange Format), BMP (Bitmap), PNM (Portable Anymap), CGM (Computer Graphics Metafile), SVG (Scalable Vector Graphics), EPS (Encapsulated PostScript), PDF (Portable Document Format), SWF (Shockwave Flash), WMF (Windows Metafile), MPEG (Moving Pictures Experts Group), among others.

The upload GUI 401 also includes a destination control 409 defined to enable specification of a location within the content library at which the hierarchical structure of folders as extracted from the compressed file is to be created. The upload GUI 401 further includes an upload control 411 defined to initiate, upon activation, an uploading process on the selected compressed files. For each compressed file to be uploaded, the uploading process includes automatically creating the hierarchical structure of folders present within the compressed file within the content library at the location specified by the destination control 409. The uploading process also includes automatically extracting the advertisement content files from the compressed file. The uploading process further includes automatically storing the extracted advertisement content files within the hierarchical structure of folders created within the content library so as to mirror disposition of the advertisement content files in the hierarchical structure of folders within the compressed file.

If multiple compressed files are selected for upload, each of the multiple compressed files is uploaded upon activation of the upload control 411. Also, in one embodiment, if a given folder in the compressed file already exists in the content library at the location specified by the destination control 409, the customer is given an option to use the previously existing version of the given folder, or to create a new version of the given folder at the specified location in the content library. Additionally, the upload GUI 401 includes a cancellation control 413 that, upon activation, cancels the upload session and closes the upload GUI 401.

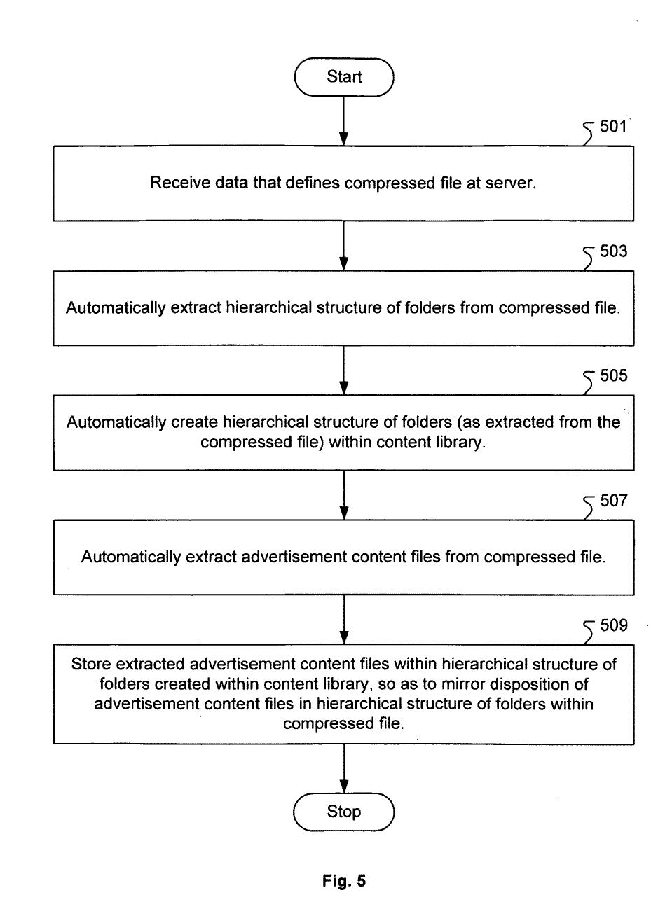

FIG. 5 shows a flowchart of a method for receiving advertisement content files within a digital advertisement platform (such as APT) operating on a server computing system, in accordance with one embodiment of the present invention. The method includes an operation 501 for receiving data at the server that defines a compressed file. The compressed file includes a hierarchical structure of folders and a number of advertisement content files disposed within the hierarchical structure of folders. In one embodiment, the compressed file is defined in a lossless compression file format that includes a central directory which defines the hierarchical structure of folders within the compressed file. In one embodiment, the compressed file is defined in a zip file format. Also, in one embodiment, the advertisement content files are defined as one or more of text content files, graphical content files, flash content files, and video content files, among others.

The method also includes an operation 503 for automatically extracting the hierarchical structure of folders from the compressed file. The method further includes an operation 505 for automatically creating the hierarchical structure of folders (as extracted from the compressed file) within a content library maintained within the digital advertisement platform. The method also includes an operation 507 for automatically extracting the advertisement content files from the compressed file. In an operation 509, the extracted advertisement content files are stored within the hierarchical structure of folders created within the content library so as to mirror disposition of the advertisement content files in the hierarchical structure of folders within the compressed file.

In one embodiment, the method also includes an operation for receiving first, second, and third external inputs. The first external input specifies the compressed file to be uploaded to the server. In one embodiment, the first external input specifies multiple compressed files to be uploaded to the server. The second external input specifies a location within the content library at which the hierarchical structure of folders as extracted from the compressed file is to be created. The third external input causes commencement of transmission of the compressed file data to the server. Additionally, in one embodiment, the method includes an operation for rendering a GUI defined to enable uploading of the compressed file to the server. In this embodiment, the GUI provides interactive controls through which the first, second, and third external inputs are respectively provided.

It should be understood that the method of FIG. 5 causes the directory hierarchy as it exists on user terminal 101 at the time of compressed file creation to be automatically recreated in the content library on the server upon uploading of the compressed file to the content library. Therefore, using the method and system for uploading advertisement content as disclosed herein, the customer is able to: 1) arrange their advertisement content folders and files therein as they wish on their local file system, 2) compress the advertisement content folders and files therein to a compressed file on their local file system, and 3) upload the compressed file to their content library on the server. Upon uploading of the compressed file, the server operates to: 1) automatically extract the advertisement content folders and files therein from the compressed file, 2) automatically create the extracted advertisement content folder hierarchy in the customer's content library on server, and 3) automatically store the extracted advertisement content files within the hierarchical structure of folders created within the content library, so as to mirror disposition of the advertisement content files in the hierarchical structure of folders within the compressed file.

With the above embodiments in mind, it should be understood that the invention may employ various computer-implemented operations involving data stored in computer systems. These operations are those requiring physical manipulation of physical quantities. Usually, though not necessarily, these quantities take the form of electrical or magnetic signals capable of being stored, transferred, combined, compared, and otherwise manipulated. Further, the manipulations performed are often referred to in terms, such as producing, identifying, determining, or comparing.

The invention can also be embodied as computer readable code on a computer readable medium. The computer readable medium is any data storage device that can store data which can be thereafter read by a computer system. Examples of the computer readable medium include hard drives, network attached storage (NAS), read-only memory, random-access memory, CD-ROMs, CD-Rs, CD-RWs, magnetic tapes, and other optical and non-optical data storage devices. The computer readable medium can also be distributed over a network coupled computer system so that the computer readable code is stored and executed in a distributed fashion.

Any of the operations described herein that form part of the invention are useful machine operations. The invention also relates to a device or an apparatus for performing these operations. The apparatus may be specially constructed for the required purposes, or it may be a general purpose computer selectively activated or configured by a computer program stored in the computer. In particular, various general purpose machines may be used with computer programs written in accordance with the teachings herein, or it may be more convenient to construct a more specialized apparatus to perform the required operations.

The above described invention may be practiced with other computer system configurations including hand-held devices, microprocessor systems, microprocessor-based or programmable consumer electronics, minicomputers, mainframe computers and the like. Although the foregoing invention has been described in some detail for purposes of clarity of understanding, it will be apparent that certain changes and modifications may be practiced within the scope of the appended claims. Accordingly, the present embodiments are to be considered as illustrative and not restrictive, and the invention is not to be limited to the details given herein, but may be modified within the scope and equivalents of the appended claims. In the claims, elements and/or steps do not imply any particular order of operation, unless explicitly stated in the claims.

What is claimed is:

1. A method for receiving advertisement content files within a digital advertisement platform operating on a server computing system, comprising:
receiving data at the server that defines a compressed file, wherein the compressed file includes a hierarchical structure of folders and a number of advertisement content files disposed within the hierarchical structure of folders;
automatically extracting the hierarchical structure of folders from the compressed file;
automatically creating the hierarchical structure of folders within a content library maintained within the digital advertisement platform;
automatically extracting the advertisement content files from the compressed file; and
storing the extracted advertisement content files within the hierarchical structure of folders created within the content library so as to mirror disposition of the advertisement content files in the hierarchical structure of folders within the compressed file.

2. A method as recited in claim 1, wherein the compressed file is defined in a lossless compression file format that includes a central directory which defines the hierarchical structure of folders within the compressed file.

3. A method as recited in claim 1, wherein the compressed file is defined in a zip file format.

4. A method as recited in claim 1, wherein the advertisement content files are defined as one or more of text content files, graphical content files, flash content files, and video content files.

5. A method as recited in claim 1, further comprising:
receiving a first external input specifying the compressed file to be uploaded to the server;
receiving a second external input specifying a location within the content library at which the hierarchical structure of folders as extracted from the compressed file is to be created; and
receiving a third external input causing commencement of transmission of the compressed file data to the server.

6. A method as recited in claim 5, further comprising:
rendering a graphical user interface defined to enable uploading of the compressed file to the server, wherein the graphical user interface provides interactive controls through which the first, second, and third external inputs are respectively provided.

7. A method as recited in claim 5, wherein the first external input specifies multiple compressed files to be uploaded to the server.

8. A system for uploading advertisement content files within a digital advertisement platform operating on a server computing system, comprising:
a content library resident on the server, wherein the content library is defined to store advertisement content files within a hierarchical structure of folders; and
a graphical user interface defined to enable uploading of advertisement content files to the content library, wherein the graphical user interface includes
a file selection control defined to enable selection of a compressed file for uploading, wherein the compressed file includes a hierarchical structure of folders and a number of advertisement content files disposed within the hierarchical structure of folders, and
an upload control defined to initiate upon activation an uploading process on the selected compressed file, wherein the uploading process includes
automatically creating the hierarchical structure of folders present within the compressed file within the content library,
automatically extracting the advertisement content files from the compressed file, and
automatically storing the extracted advertisement content files within the hierarchical structure of folders created within the content library so as to mirror disposition of the advertisement content files in the hierarchical structure of folders within the compressed file.

9. A system as recited in claim 8, wherein the file selection control is defined to enable selection of multiple compressed files for uploading, wherein each of the multiple compressed files is uploaded upon activation of the upload control.

10. A system as recited in claim 8, wherein the graphical user interface further includes a destination control defined to enable specification of a location within the content library at which the hierarchical structure of folders as extracted from the compressed file is to be created.

11. A system as recited in claim 8, wherein the compressed file is defined in a lossless compression file format that includes a central directory which defines the hierarchical structure of folders within the compressed file.

12. A system as recited in claim 8, wherein the compressed file is defined in a zip file format.

13. A system as recited in claim 8, wherein the advertisement content files are defined as one or more of text content files, graphical content files, flash content files, and video content files.

14. A computer readable storage medium having program instructions stored thereon for receiving advertisement content files within a digital advertisement platform operating on a server computing system, comprising:
program instructions for receiving data at the server that defines a compressed file, wherein the compressed file includes a hierarchical structure of folders and a number of advertisement content files disposed within the hierarchical structure of folders;
program instructions for automatically extracting the hierarchical structure of folders from the compressed file;
program instructions for automatically creating the hierarchical structure of folders within a content library maintained within the digital advertisement platform;
program instructions for automatically extracting the advertisement content files from the compressed file; and
program instructions for storing the extracted advertisement content files within the hierarchical structure of folders created within the content library so as to mirror disposition of the advertisement content files in the hierarchical structure of folders within the compressed file.

15. A computer readable storage medium as recited in claim 14, wherein the compressed file is defined in a lossless compression file format that includes a central directory which defines the hierarchical structure of folders within the compressed file.

16. A computer readable storage medium as recited in claim 14, wherein the compressed file is defined in a zip file format.

17. A computer readable storage medium as recited in claim 14, wherein the advertisement content files are defined as one or more of text content files, graphical content files, flash content files, and video content files.

18. A computer readable storage medium as recited in claim 14, further comprising:
program instructions for receiving a first external input specifying the compressed file to be uploaded to the server;
program instructions for receiving a second external input specifying a location within the content library at which the hierarchical structure of folders as extracted from the compressed file is to be created; and
program instructions for receiving a third external input causing commencement of transmission of the compressed file data to the server.

19. A computer readable storage medium as recited in claim 18, further comprising:
program instructions for rendering a graphical user interface defined to enable uploading of the compressed file to the server, wherein the graphical user interface provides interactive controls through which the first, second, and third external inputs are respectively provided.

20. A computer readable storage medium as recited in claim 18, wherein the first external input specifies multiple compressed files to be uploaded to the server.
